(19) United States
(12) Patent Application Publication
(10) Pub. No.: US 2008/0069278 A1
(43) Pub. Date: Mar. 20, 2008

(54) Asynchronous Phase Rotator Control

(76) Inventors: Steven J. Baumgartner, Zumbro Falls, MN (US); Anthony R. Bonaccio, Shelburne, VT (US); Timothy C. Buchholtz, Rochester, MN (US); Charles P. Geer, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/533,105

(22) Filed: Sep. 19, 2006

(51) Int. Cl. H04L 7/00

(52) U.S. Cl. 375/354

(57) ABSTRACT

The present invention generally relates to centering a clock edge at or near the center of a data eye. Data may be sent from a first device to a second device in conjunction with a clock signal. A phase rotator operating in an external clock domain governed by the clock signal received at the second device may rotate the phase of the received clock signal to sample data. The data sampled in the unstable external clock domain may be transferred to a stable local clock domain for analysis. Feedback may be provided from the stable clock domain to the phase rotator to adjust the phase of the received clock signal to position an edge of the clock signal at or near the center of the data eye.

### BACKGROUND OF THE INVENTION

1. Field of the Invention

The present invention generally relates to exchanging data between electronic devices, and more specifically to aligning a clock and data signal at a device receiving data.

2. Description of the Related Art

In modern computer systems, data is often exchanged between devices over a high speed serial communications bus with multiple data lines. Each device commonly includes serialization circuitry to serialize parallel data to be sent serially over each data line and de-serialization circuitry to assemble and present in parallel (e.g., to other data processing components on the receiving device) data received serially over a data line.

Data on a given data line is usually captured at the edge of a clock signal at the receiving device. The clock signal may be generated and sent to the receiving device by the device sending data. To properly capture the data on the data line, the edge of the clock signal must capture the data at a stable point in time.

The period during which data is available on a data line is commonly referred to as the data “eye” due to the corresponding shape in a timing diagram, as illustrated in FIG. 1A. In the ideal timing shown in the eye diagram 100 of FIG. 1A, each data transition is perfectly separated by a single bit unit interval (BUI) 102. Also illustrated in FIG. 1A are time period 103 during which data is stable, and periods 104 during which data is unstable on the data line.

A common problem with capturing data from the data lines is that the sampling clock signal may not be aligned with the data when received at the receiving device. For example, as illustrated in FIG. 1B, digital communications channels often experience some amount of low or high frequency deviations from ideal timing (labeled as Δt), commonly referred to as jitter. The misalignment of the clock and data signals may be caused due to a wide variety of factors including variations in lengths of the data and clock lines and variations in temperature, processes, and the like. Sufficiently large time deviations can result in data errors. For example, data may be sampled from a bit frame that is earlier or later than that intended bit frame or the data may be sampled during an unstable time period 104.

Aligning a clock signal to a data signal may involve the use of a phase rotator. Phase rotators, also known as phase interpolators, are typically used to construct an output signal having a phase that is related to the phase of a second signal in some desirable way. For example, phase rotators are often used in serial data transmission and receiving circuitry as a component for aligning a sampling clock to recover serial data. Phase rotators typically generate an output signal having a phase with a known relationship to the serial data. The output signal is typically generated from a mix of incoming signals having defined offset phase relationships (commonly referred to as phasors). For example, a phase rotator may be used to produce a sampling clock signal aligned with a center point 105 of the data eye, in an effort to ensure the data is sampled when valid and allow for some tolerance.

However one problem with prior art phase rotators is that they are controlled by the clock signal received from the sending device. For example, the control logic that determines the output of the phase rotators may operate on the received clock signal. However, the clock signal received from the device sending data may be very unstable. For example, during the initiation of communication between the devices, the clock signal may not be available at the receiving device for an initial period of time. Furthermore, the clock signal from the sending device may be subject to periodic skewing and jittering due to temperature and process variations, and other factors. Such instability in the clock signal may adversely affect the control of the phase rotator and the generation of an effective sampling clock signal to sample incoming data.

Accordingly, what is needed are methods, systems, and articles of manufacture for providing more efficient control of phase rotators.

### SUMMARY OF THE INVENTION

The present invention generally relates to exchanging data between electronic devices, and more specifically to aligning a clock and data signal at a device receiving data.

One embodiment of the invention provides a method for positioning a clock edge at or near a center of a data eye. The method generally comprises receiving, at a first device, data and an external clock signal sent from a second device and sampling the data received at the first device in an external clock domain using a sampling clock signal generated by shifting a phase of the external clock signal. The method further comprises transferring the sampled data to a local clock domain in the first device, analyzing the sampled data in the local clock domain to determine whether the sampling clock allows sampling data at or near the center of the data eye for received data, and adjusting the shifting of phase of the external clock signal based on the analysis performed in the local clock domain to adjust the sampling clock signal to allow sampling of data at or near the center of the data eye.

Another embodiment of the invention provides an integrated circuit generally comprising a phase rotator configured to operate in a first clock domain, and generate a sampling clock signal by shifting a phase of an external clock signal received by the integrated circuit, wherein the sampling clock signal is used to sample data received by the integrated circuit. The integrated circuit further comprises control logic configured to operate in a second clock domain, and determine whether an edge of the sampling clock signal samples data at or near a center of a data eye for received data, and provide feedback to the phase rotator for adjusting the phase of the external clock signal to generate the sampling clock signal.

Yet another embodiment of the invention provides a system, generally comprising a first device configured to transmit data and an external clock signal, and a second device, configured to receive the data and the external clock signal. The second device may generally include a phase rotator, a buffer, and control logic. The phase rotator may be configured to generate a sampling signal by adjusting a phase of the external clock signal, wherein the sampling signal is configured to provide a clock edge for sampling the received data. The buffer may be configured to receive sampled data in an external clock domain governed by the external clock and output the sampled data in a local clock domain of the second device. The control logic may be configured to retrieve the sampled data from the buffer, determine whether the sampled data is sampled at or near a center of a data eye for the received data, and provide feedback to the phase rotator for adjusting the phase of the external clock signal, wherein the control logic is configured to operate in the local clock domain.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B illustrate exemplary data eye diagrams.

FIG. 2 illustrates an exemplary system according to an embodiment of the invention.

FIG. 3 illustrates an exemplary phase rotator.

FIG. 4 is a table of exemplary phasor weights and corresponding phase outputs for the phase rotator of FIG. 3.

FIGS. 5A1 and 5A2 illustrate an exemplary table for associating binary values with gray code values and thermometer code, according to an embodiment of the invention.

FIG. 5B illustrates the conversion of binary code to gray code according to an embodiment of the invention.

FIG. 5C illustrates the conversion of gray code to thermometer code according to an embodiment of the invention.

FIG. 5D illustrates the generation of a 90 degree shifted gray code according to an embodiment of the invention.

FIG. 6 is an exemplary flow diagram for centering a clock edge at the center of a data eye, according to an embodiment of the invention.

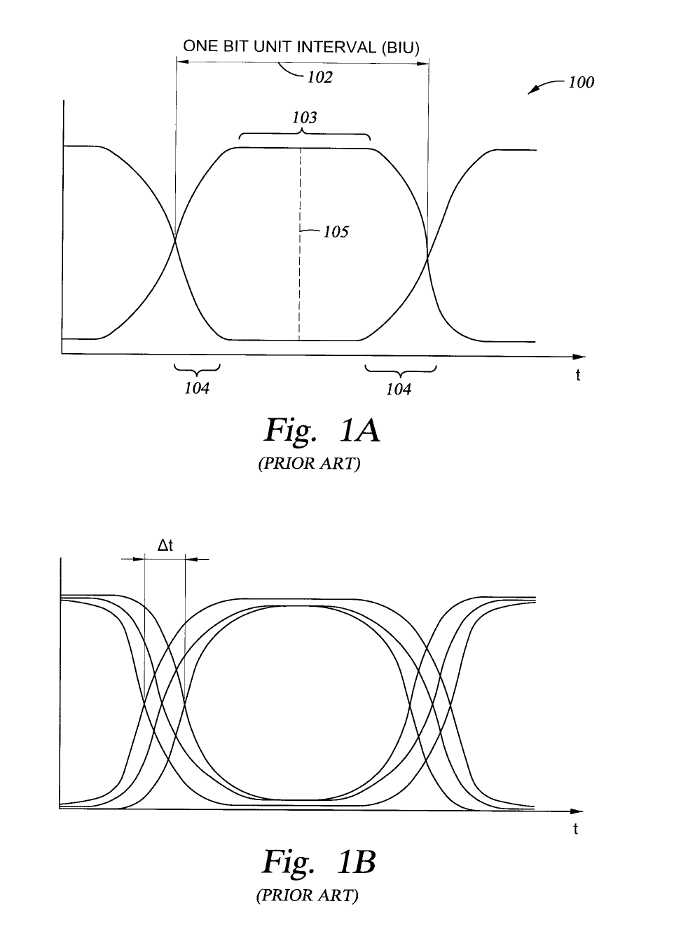

### DETAILED DESCRIPTION OF THE PREFERRED EMBODIMENTS

The present invention generally relates to centering a clock edge at or near the center of a data eye. Data may be sent from a first device to a second device in conjunction with a clock signal. A phase rotator operating in an external clock domain governed by the received clock at the second device may rotate the phase of the received clock signal to sample data. The data sampled in the unstable external clock domain may be transferred to a stable local clock domain for analysis. Feedback may be provided from the stable clock domain to the phase rotator to adjust the phase of the received clock signal to position an edge of the clock signal at or near the center of the data eye.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

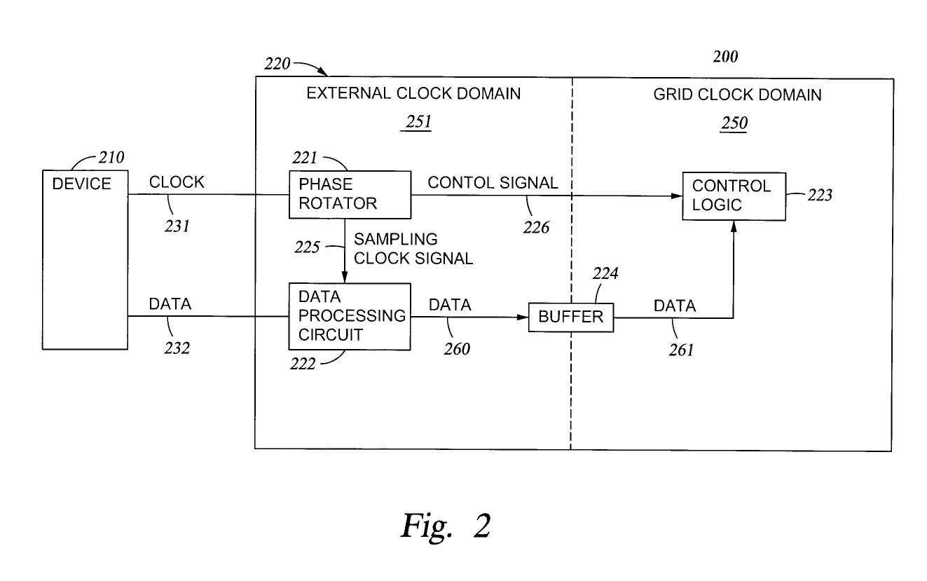

FIG. 2 is an illustration of an exemplary system 200 in which embodiments of the invention may be implemented. As illustrated in FIG. 2, system 200 includes a first device 210 and a second device 220 communicably coupled with each other. The first device 210 and second device 220 may be integrated circuits configured to exchange data over an interconnect bus connecting the integrated circuits (ICs). For example, device 210 may be configured to send a clock signal 231 and a data signal 232 to device 220. One skilled in the art will recognize that device 220 may be configured to send similar clock and data signals (not illustrated in FIG. 2) to device 210. In a particular embodiment, device 210 may be a central processing unit (CPU) and device 220 may be a graphics processing circuit (GPU).

As illustrated in FIG. 2, device 220 may include a phase rotator 221, data processing circuit 222, control logic 223 and a buffer 224. Phase rotator 221 may be configured to generate a sampling clock signal 225 to drive data processing circuit 222. Sampling clock signal 225 may be generated based on the clock signal 231. For example, sampling clock signal 225 may be generated by shifting the phase of clock signal 231 to produce clock edges at the center of the data eye for data received at device 220.

The phase shifting of clock signal 231 may be based on a control signal 226 received by phase rotator 221 from control logic 223. For example, control signal 226 may indicate the amount of shifting required to center the edge of clock signal 231 at the center of the data eye.

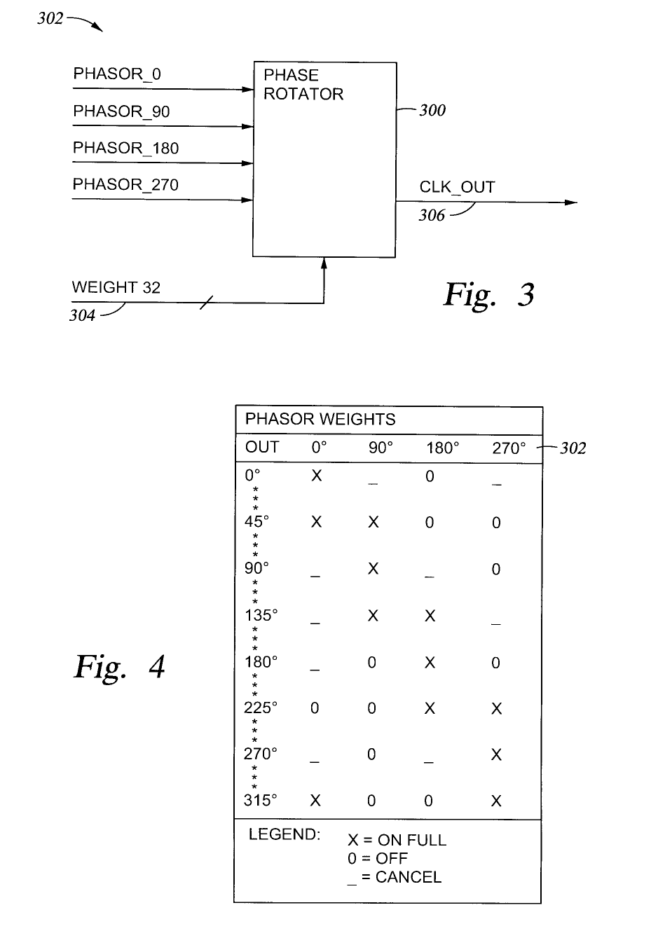

FIG. 3 illustrates an exemplary phase rotator 300 according to an embodiment of the invention. As illustrated in FIG. 3, phase rotator 300 generates a clock signal 306 by mixing four phasors 302 with relative phase offsets of 0 degrees, 90 degrees, 180 degrees, and 270 degrees, in N discrete combinations (by applying different weights to each) to create an output signal with N discrete phases between 0 and 360 degrees. Clock signal 306 may correspond to the sampling clock signal 225 illustrated in FIG. 2.

Weights to be applied to each phasor 302 may be specified by a weight code 304 (illustratively, a string of 32 bits). As illustrated in FIG. 4, which lists exemplary phasor weights and resultant output phases, the entire unit circle (0-360 degrees) can be achieved by mixing various weights of either 2 or 3 of the input phasors 302. The table shows output phases at 45 degree increments. At these points, the phasor weights are always either off or on fully to create the phases as shown. In between these points there is an interpolation applied to create the intermediate phases.

The weighting function may be fairly close to linear. For example, at 45 degrees the 0 and 90 degree phasor weights are on full and the 180 and 270 weights are off. For the next phase step (e.g., about 51 degrees, assuming 64 phase steps of approx. 6 degrees each) the 0 weight would be decreased slightly from its max value, pulling the output phase toward 90.

Referring back to FIG. 2, data processing circuit 222 may be configured to receive serial bits of data in conjunction with a clock signal, for example, clock signal 231. For example, data processing circuit 222 may capture the data received on data line 232. The data may be captured at an edge of sampling clock signal 225, wherein the sampling clock signal 225 is generated based on clock signal 231 and is configured to produce a clock edge at or near the center of the data eye for data received on data line 232.

In one embodiment of the invention data processing circuit 222 may receive multiple sampling clock signals from phase rotator 221 to sample data at the center and the edges of the data eye. In one embodiment, phase rotator 221 may generate multiple sampling clock signals 225 with different relative offsets to sample data at different locations in the data eye. For example, in one embodiment, the phase rotator may generate a 90 degree shifted clock signal. The 90 degree shifted clock signal may be configured to sample the data eye at an edge of the data eye. By retrieving samples of data from multiple locations in the data eye, for example, at the center and the edges of the data eye, a better analysis of the position of the clock edge with respect to the center of the data eye may be possible.

As illustrated in FIG. 2, phase rotator 221 and data processing circuit 222 operate in an external clock domain governed by clock signal 231. As previously described, clock signal 231 may by subject to jitter and shifting due to temperature variations, process variations, and the like. Therefore, the sampling clock signal generated by the phase rotator may not sample data at the center of the data eye, thereby increasing the chances of capturing incorrect data. For example, data may be captured from a previous, or a subsequent, data eye, or the data may be captured at the edges of the data eye where the data is unstable.

Therefore, the sampling clock signal may have to be realigned at the center of the data eye. To center the edge of the of the sampling clock signal at the center of the data eye, the edge and data samples captured by data processing circuit 222 may be analyzed, and the clock signal 231 shifted based on the analysis of the sampled to generate a sampling clock signal with an edge at the center of the data eye.

To prevent the analysis of the edge and data sampled from being performed in the unstable external clock domain, embodiments of the invention transfer the edge and data samples from the unstable external clock domain to a more stable local clock domain governed by a stable and steady local clock. For example, the edge and sample may be transferred from the external clock domain 251 to a local clock domain 250. Control logic in the local clock domain may analyze the sampled data and provide feedback to the phase rotator to generate the sampling clock signal with an edge at the center of the data eye.

To transfer sampled data from the external clock domain 251 to the local clock domain 250, Data processing circuit 222 may send the sampled data and edge data 260 to buffer 224. Buffer 224 may provide an interface between two clock domains as illustrated in FIG. 2. Data may be written into buffer 224 in an external clock domain 251 governed by the received clock signal 231. However, data may be retrieved from buffer 224 in a grid clock domain 250 governed by a local grid clock.

In one embodiment of the invention, data processing circuit 222 may sample a plurality of bits of data received on a bit line before transferring the sampled data and edge data to buffer 224. For example, in one embodiment, data processing circuit may recover 4 bits of serial data. Data processing circuit 222 may transfer the sampled data to a front side bus for use by components in device 220. The sampled data may also be transferred to buffer 224.

One skilled in the art will recognize that the number of bits sampled is not limiting on the invention. Any reasonable number of bits may be sampled and transferred to buffer 224. The number of bits sampled may depend on the relation between the data transfer rate and the grid clock frequency. For example, in one embodiment, the grid clock frequency may be ¼^{th} the frequency of data transfer. Therefore, 4 bits may be sampled before each transfer.

The number of bits sampled may also depend on the amount of time required to analyze the bits before adjusting the phase rotator. For example, a larger number of bits may require a greater amount of time for analysis, thereby delaying the adjusting of the phase rotator.

In one embodiment of the invention, the local grid clock in device 220 may be configured to operate at the same frequency as clock 231. The grid clock, however, may be phase asynchronous from clock 231. In other words, clock 231 and the grid clock may operate at the same frequency but may have different phase shifts. Moreover, the phase difference between the external clock domain and the grid clock domain may vary over time due to the instability of the external clock 231. For example, clock 231 may experience periodic jittering which may vary the phase of clock 231 relative to the grid clock.

One advantage of the grid clock domain is the relative stability and reliability of the grid clock relative to the external clock 231. Therefore, embodiments of the invention perform analysis of sampled data in the grid clock domain to adjust the sampling clock signal(s) 225. For example, the data (and edge data) sampled by data processing circuit 222 and written to buffer 224 may be analyzed in the grid clock domain to determine the offset for clock 231 for generating the sampling clock signal 225.

Accordingly, control logic 223 may read data 261 from data buffer 224. Data 261 may correspond to the data 260 written into buffer 224 by data processing circuit 222 in the external clock domain. As illustrated in FIG. 2, control logic 223 may operate in the grid clock domain 250. Control logic 223 may analyze the data and edge data samples to determine whether the data sampled by the data processing circuit is being captured at or near the center of the data eye.

If data is not being sampled at or near the center of the data eye, control logic 223 may provide feedback to phase rotator 221 indicating the need to adjust the offset applied to clock 231 to generate the sampling signal 225. For example, control logic 223 may generate a control signal 226 indicating the phase shift necessary to sample data at or near the center of the data eye.

One advantage of analyzing sampled data in a separate, stable grid clock environment is that the control logic need not make unnecessary corrections to the sampling clock signal in response to short term jittering effects. For example, if the sampling clock signal is adjusted based on every bit of sampled data, the sampling clock signal may be subjected to a great amount of jitter and discontinuities. In some embodiments, control logic 223 may analyze data samples for multiple bits of data to determine a long term average shift in the clock edge from the center of the data eye. Therefore, instantaneous correction of the sampling clock signal for infrequent, short term effects on clock signal 225 may be avoided.

In one embodiment of the invention, phase rotator 221 may rotate the received clock signal 231 in 64 discrete steps to generate the sampling clock signal 225, as previously described. Accordingly, control logic 223 may include a 6-bit clock control register to indicate all possible degrees of rotation.

In one embodiment of the invention, to transfer the control data from the control logic, which operates in the grid clock domain, to the phase rotator, which operates in the external clock domain, the control data in the clock control register may be converted into 6-bit gray code. As is well known in the art, gray code is a binary numeral system wherein two successive numbers differ in only one digit.

One skilled in the art will recognize that by transferring the control data from the control logic operating in the grid clock domain to the phase rotator in the external clock domain using gray code ensures that only one bit changes each time data is sent across the bus connecting the control logic to the phase rotator. Therefore, the need to time data transferred across the bus bridging different time domains is obviated.

Phase rotator 221 may convert the 6-bit gray code into a thermometer code controlling the digital to analog (DAC) converters generating the sampling clock signal 225. For example, phase rotator 221 may include a decoder to convert the 6 bit gray code to thermometer code controlling the clock generation. As each bit of the gray code is altered, a corresponding bit of the thermometer code may also be altered, thereby shifting the clock edge.

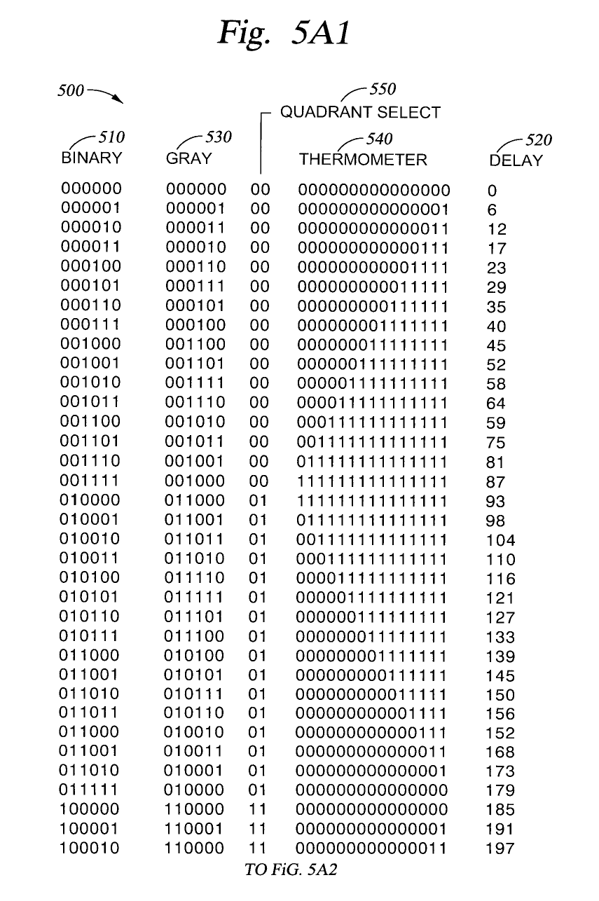

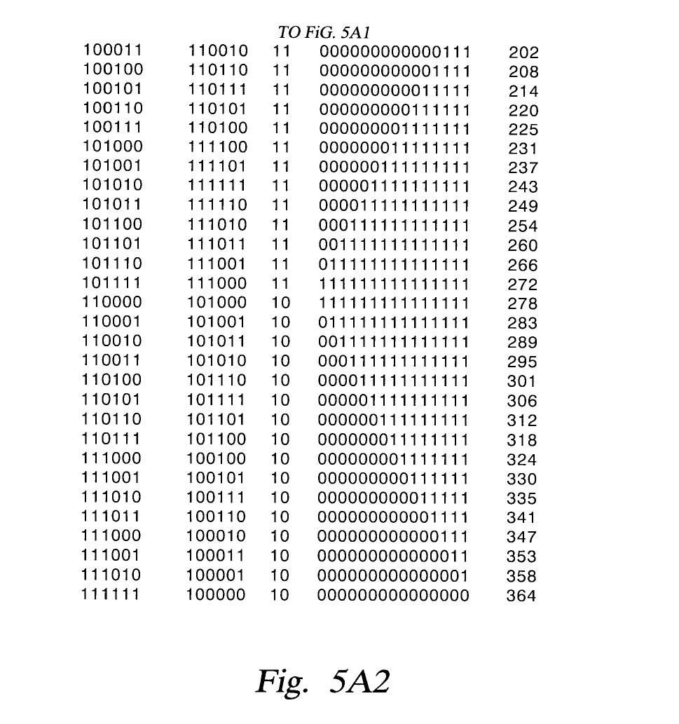

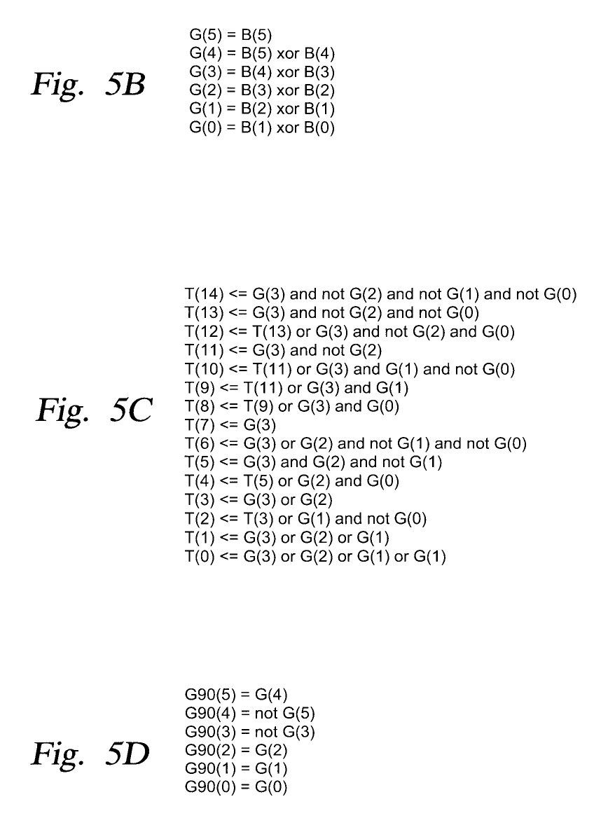

FIGS. 5A1 and 5A2 illustrate an exemplary table 500 that may be used to associate a 6 bit binary value to a 6 bit gray code value, and the 6 bit gray code value to thermometer code. As illustrated in column 510 of table 500, the binary values represent 64 possible delays for an incoming clock signal. For example, with each increment of the binary value, the incoming clock may be shifted by approximately 6 degrees, as illustrated in the delay column 520.

Column 530 of Table 500 illustrates the gray code value associated with each binary value. As illustrated in FIG. 5Al and 5A2, each successive gray code value is derived by altering a single bit from the previous gray code value. The gray code value may be derived from the binary code based on a predetermined algorithm.

FIG. 5B illustrates an exemplary algorithm for converting binary code to gray code. Each bit of the gray code value is shown in FIG. 5B. For example, G(5) represents the most significant bit of the 6 bit gray code. The value of a gray code bit may depend on the value of one or more binary bits B. For example, the value of G(5) is the same as the value of B(5), the value of G(4) is the value of B(5) XOR'ed with B(4), and so on.

The gray code derived from a binary value may be latched to ensure there are no timing hazards over the bus connecting control logic 223 to phase rotator 221. One skilled in the art will recognize that because the path connecting the phase rotator and the control logic is an untimed path, delay over the path may not pose a problem.

As previously described, the phase rotator may convert the 6-bit gray code to thermometer code that generates sampling signal 225. Column 540 of Table 500 illustrates exemplary thermometer code that may be associated with the gray code received from the control logic. In the exemplary embodiment illustrated in Table 500, the thermometer code may be generated from 4 bits of the 6-bit gray code. For example, the thermometer code may be derived from the 4 least significant bits of the gray code. The thermometer code may control, for example, the weights associated with phasors controlling the phase rotator.

FIG. 5C illustrates an exemplary algorithm for converting the 4 least significant bits of the gray code to thermometer code. FIG. 5C illustrates the derivation of each bit of the thermometer code T. As illustrated, the value of a particular bit of thermometer code may depend on one or more gray code bits and/or one or more other thermometer code bits.

The two most significant bits of the gray code may determine the quadrant in which the phase is adjusted. For example, the two bits may determine the adjustment of phase in one of four quadrants. In one embodiment, the two-bit quadrant code may be derived directly from the two most significant bits of the gray code. The quadrant codes according to this scheme is illustrated in column 550 of Table 500.

One advantage of the scheme described above is that the phase rotator may be controlled by the use of a relatively few number of bits. For example, the control logic need only send a 6 bit gray code value across the bus connecting the control logic and the phase rotator to generate the 15 bit thermometer code and 2 bit quadrant code that controls the generation of the sampling signal. Therefore, the phase rotator may be controlled quickly, without timing concerns across the external and local clock domains, and with a minimum number of interface lines.

A further advantage is that multiple clock signals may be generated based on the same gray code value sent across the interface. For example, the gray code value sent from the control logic to the phase rotator may be used to generate sampling clock signals for sampling data at the center and the edges of the data eye.

For example, FIG. 5D illustrates an algorithm for converting gray code for sampling data at the center of the data eye to gray code for sampling data at the edges of the data eye G90. G90 may represent gray code for generating a 90 degree offset sampling signal. Each bit of the 6 bit gray code G90 may be determined by a single bit of the gray code G, as illustrated in FIG. 5D. Because a single gray code G bit determines the value of a gray code G90 bit, the phase rotator may be controlled with fewer lines and without hazards across the interface of the time domains. The G90 gray code value may be generated from the G gray code value before decoding the gray code values into thermometer code.

Referring back to FIG. 2, control logic 223 may drive a bus connecting the control logic and the phase rotator with a first gray code value. A decoder in the phase rotator may generate thermometer code corresponding to the gray code value. The thermometer code may determine the phase of shift of the incoming clock signal. Subsequently, control logic 223 may generate a second gray code value. One skilled in the art will recognize that the first and second gray code value may differ in only one bit. The second gray code value may alter a corresponding thermometer code bit, thereby shifting the phase of the incoming clock signal by one step. Therefore, by generating a sequence of gray code values, control logic 223 may smoothly shift the phase of the incoming clock signal.

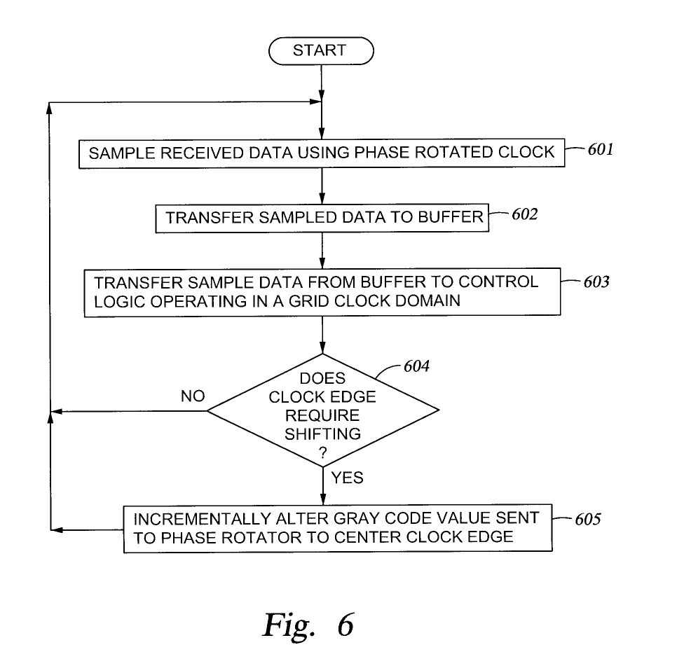

FIG. 6 is a flow diagram of exemplary operations performed to center a clock edge at the center of a data eye. The operations begin in step 601 by sampling data received from a first device at a second device. For example, as previously described, the first device may send data in conjunction with a clock signal to the second device. The second device may include a phase rotator to shift the phase of the received clock signal to align a clock edge of the received clock signal at the center of the data eye for received data.

In step 602, the sampled data may be transferred to a buffer, for example buffer 224 in FIG. 2. As described earlier, the sampled data may be transferred to buffer 224 in an external clock domain governed by the clock signal received from the first device. The sampled data may include, for example, the value of the data at the center and the edges of the data eye. In one embodiment the sampled data may include data samples for multiple bits, including the data samples at the center and edge of the data eye for each bit.

In step 603, the sampled data may be transferred from the buffer to control logic operating in a grid clock domain. Because the grid clock domain is governed by a local clock that is more stable and more reliable than the clock signal received from the first device, the control logic may perform more reliable analysis of the sampled data to determine, in step 604, whether the phase rotated clock signal generated by the phase rotator is sampling data at the center of the data eye.

In step 604, control logic may examine the sampled data to determine whether the incoming clock signal is aligned with the incoming clock signal. If it is determined that the phase rotated clock signal requires shifting to center the edge of the clock at or near the center of the data eye, the control logic may send a control signal indicating the required phase shift in step 605. For example, the control logic may transfer a sequence of gray code values to the phase rotator. The sequence of gray code values may smoothly shift the phase of the incoming clock signal smoothly to the center of the data eye. For example, each gray code value may be decoded to thermometer code controlling digital to analog filters that generate the phase rotated clock.

By allowing the analysis of accumulated sampled data in a stable and reliable grid clock domain, embodiments of the invention allow for more effective control of the phase rotator generating a phase rotated clock for sampling data. One skilled in the art will recognize that while a single data line 232 and associated phase rotator 221 and data capturing circuit 222 are illustrated in FIG. 2, embodiments of the invention may include multiple data bit lines transferring data from device 210 to device 220. Accordingly, each data bit line may include its own phase rotator and data processing circuits.

While the foregoing is directed to embodiments of the present invention, other and further embodiments of the invention may be devised without departing from the basic scope thereof, and the scope thereof is determined by the claims that follow.

What is claimed is:

1. A method for positioning a clock edge at or near a center of a data eye, comprising:
receiving, at a first device, data and an external clock signal sent from a second device;
sampling the data received at the first device in an external clock domain using a sampling clock signal generated by shifting a phase of the external clock signal;
transferring the sampled data to a local clock domain in the first device;
analyzing the sampled data in the local clock domain to determine whether the sampling clock allows sampling data at or near the center of the data eye for received data; and
adjusting the shifting of phase of the external clock signal based on the analysis performed in the local clock domain to adjust the sampling clock signal to allow sampling of data at or near the center of the data eye.

2. The method of claim 1, sampling the data received at the first device comprises sampling the data at or near an edge of the data eye to generate edge data, wherein the edge data is a part of the sampled data.

3. The method of claim 1, wherein transferring the sampled data to the local clock domain comprises transferring the data to a buffer configured to receive the sampled data in the external clock domain and output the sampled data in the local clock domain.

4. The method of claim 3, wherein transferring sampled data to the buffer comprises transferring sampled data for multiple bits of data received at the first device.

5. The method of claim 1, wherein adjusting the shifting of phase of the external clock signal comprises transferring a gray code value from the local clock domain to the external clock domain, the gray code value indicating a phase shift for the external clock signal.

6. The method of claim 1, wherein the external clock signal and a local clock signal associated with the local clock domain operate at substantially the same frequency.

7. The method of claim 6, wherein the external clock signal and the local clock signal are phase asynchronous.

8. An integrated circuit, comprising:
a phase rotator configured to operate in a first clock domain, and generate a sampling clock signal by shifting a phase of an external clock signal received by the integrated circuit, wherein the sampling clock signal is used to sample data received by the integrated circuit; and
control logic configured to operate in a second clock domain, and:
determine whether an edge of the sampling clock signal samples data at or near a center of a data eye for received data; and
provide feedback to the phase rotator for adjusting the phase of the external clock signal to generate the sampling clock signal.

9. The integrated circuit of claim 8, further comprising a buffer configured to transfer sampled data from the first clock domain to the second clock domain.

10. The method of claim 8, wherein the control logic is configured to transfer a gray code value to the phase rotator in the first clock domain, the gray code value indicating the adjustment in phase for the external clock signal.

11. The method of claim 8, wherein the first clock domain and the second clock domain are phase asynchronous.

12. The integrated circuit of claim 8, wherein the edge of the sampling clock signal is configured to sample at or near one of:
the center of the data eye; and
the edge of the data eye.

13. A system, comprising:
a first device configured to transmit data and an external clock signal; and
a second device, configured to receive the data and the external clock signal, the second device comprising,
a phase rotator configured to generate a sampling signal by adjusting a phase of the external clock signal, wherein the sampling signal is configured to provide a clock edge for sampling the received data,
a buffer configured to receive sampled data in an external clock domain governed by the external clock and output the sampled data in a local clock domain of the second device, and
control logic configured to retrieve the sampled data from the buffer, determine whether the sampled data is sampled at or near a center of a data eye for the received data, and provide feedback to the phase rotator for adjusting the phase of the external clock signal, wherein the control logic is configured to operate in the local clock domain.

14. The system of claim 13, further comprising a data processing circuit configured to sample the data received from the first device, wherein sampling data comprises capturing the data at the clock edge of the sampling clock signal.

15. The system of claim 14, wherein the clock edge is configured to sample data at or near the center of the data eye.

16. The system of claim 14, wherein the clock edge is configured to sample data at or near an edge of the data eye.

17. The system of claim 13, wherein the external clock signal and a local clock signal associated with the local clock domain operate at the same frequency.

18. The system of claim 17, wherein the external clock signal and the local clock signal are phase asynchronous.

19. The system of claim 17, wherein the control logic is configured to transfer a gray code value from the local clock domain to the phase rotator in the external clock domain, the gray code value indicating the adjustment in phase for the external clock signal.

20. The system of claim 17, wherein the first device is a central processing unit and the second device is a graphics processing unit.
